(19) United States
(12) Patent Application Publication
(10) Pub. No.: US 2017/0374623 A1
(43) Pub. Date: Dec. 28, 2017

(54) Managing Power Resources of an Internet of Everything (IoE) Device

(71) Applicant: QUALCOMM Incorporated, San Diego, CA (US)

(72) Inventors: Nilotpal Dhar, Hyderabad (IN); Santosh V.S. Ganji, Hyderabad (IN); Guruvayurappan Vasudevan, Hyderabad (IN); Asimava Bera, Hyderabad (IN)

(21) Appl. No.: 15/191,757

(22) Filed: Jun. 24, 2016

(51) Int. Cl. H04W 52/02; H04W 72/04; H04L 29/08; H04W 24/10; H04W 76/02; H04W 72/08

(52) U.S. Cl. CPC H04W 52/0258; H04W 76/02; H04W 72/082; H04L 67/12; H04W 24/10; H04W 72/0473

(57) ABSTRACT

Embodiments include systems and methods for managing power resources of an Internet of Everything (IoE) device. A processor of the IoE device may monitor an uplink interference over time. The device processor may calculate wireless communication parameters based on the monitored uplink interference over time, and may store in a memory the calculated wireless communication parameters. The device processor may calculate a transmit power based on one or more stored wireless communication parameters associated with a transmit time, and may transmit to a communication network a request to establish a communication link using the calculated transmit power.

### BACKGROUND

Computing devices that include wireless communication capabilities are becoming smaller, cheaper, and increasingly ubiquitous. Such computing devices are being incorporated with more and more objects, gradually creating a massively distributed network of computing devices generally referred to as the Internet of Things or the Internet of Everything (IoE). Many types of devices with wireless communication capabilities are expected to participate in the IoE as network nodes using wireless communication.

Some IoE devices may be deployed in locations or areas that lack ready access to a power source or recharging source. Such devices require long battery life. One major power resource management issue arises from the IoE device's need to periodically establish a network communication link.

To establish a communication link with a wireless communication network (e.g., cellular communication network), an IoE device may power up from a low power mode (such as an idle mode or a sleep mode) and may search for a network signal (e.g., from a base station or access point of the wireless communication network). If the IoE device detects a network signal, the IoE device may attempt to acquire system information that is broadcast from the base station or access point. The IoE device may then calculate an initial transmit power for a request to establish the communication link, such as a Random Access Channel (RACH) request, and transmit a first RACH request using the calculated initial transmit power. If the IoE device does not receive a response or acknowledgement from the base station, the IoE device may increase the transmit power and transmit a second RACH request. The IoE device may repeat this process until an acknowledgement or response is received from the base station, or until the IoE device ultimately determines a RACH request failure.

This process consumes power stored in the battery of the IoE device. In addition, if a RACH request collides with another IoE device's RACH request, the process may be prolonged, further wasting the IoE device's stored power.

### SUMMARY

Various embodiments and implementations include methods implemented on an Internet of Everything (IoE) device for managing power resources of the IoE device. Various embodiments and implementations may include monitoring an uplink interference over time by a device processor of the IoE device, calculating, by the device processor, wireless communication parameters based on the monitored uplink interference over time, storing in the calculated wireless communication parameters a memory of the IoE device, calculating, by the device processor, a transmit power based on one or more stored wireless communication parameters associated with a transmit time, and transmitting to a communication network a request to establish a communication link using the calculated transmit power. In some embodiments, the uplink interference may include uplink interference in a cell of the communication network.

In some embodiments, calculating the transmit power based on the stored wireless communication parameters at a transmit time may include correlating, by the device processor, the transmit time and the stored wireless communication parameters. Some embodiments may further include determining, by the device processor, whether the IoE device has data to transmit, and correlating the transmit time and the stored wireless communication parameters by the device processor in response to determining that the IoE device has data to transmit.

Some embodiments may further include determining, by the device processor, whether the request to establish the communication link is successful, and calculating, by the device processor, a second transmit power based on the stored wireless communication parameters at the transmit time in response to determining that the transmitted request is not successful. Some embodiments may further include establishing a communication link with the communication network in response to determining that the request to establish the communication link is successful, and storing in the memory the successful transmit power.

Some embodiments may further include determining, by the device processor, a transmit time based on the stored wireless communication parameters. Some embodiments may further include determining, by the device processor, a transmit time based on the stored wireless communication parameters and a second transmit time of one or more other IoE devices. Some embodiments may further include receiving from one or more other IoE devices second wireless communication parameters, and storing in the memory the second wireless communication parameters.

Further embodiments include an IoE device including a processor configured with processor-executable instructions to perform operations of the embodiment methods summarized above. Further embodiments include a non-transitory processor-readable storage medium having stored thereon processor-executable software instructions configured to cause a processor to perform operations of the embodiment methods summarized above. Further embodiments include an IoE device that includes means for performing functions of the embodiment methods summarized above.

### BRIEF DESCRIPTION OF THE DRAWINGS

The accompanying drawings, which are incorporated herein and constitute part of this specification, illustrate various embodiments, and together with the general description given above and the detailed description given below, serve to explain the features of various embodiments.

FIG. 1 is a system block diagram of a communication environment in which the various embodiments may be used.

FIG. 2 is a component block diagram illustrating a wireless network node suitable for use with various embodiments.

FIG. 3 is a process flow diagram illustrating a method for managing power resources of an Internet of Everything (IoE) device according to various embodiments.

FIG. 4 is a process flow diagram illustrating a method for managing power resources of an IoE device according to various embodiments.

FIG. 5 is a process flow diagram illustrating a method for managing power resources of an IoE device according to various embodiments.

FIG. 6 is a process flow diagram illustrating a method for managing power resources of an IoE device according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments provide methods for managing resource consumption by a wireless access point based on a network load of the access point and radio capabilities of clients that are associated with the access point. In particular, information regarding successfully establish communication links may be saved in memory so that such information may be used later to more efficiently connect to the network.

The term “IoE device” is used herein to refer to a wireless device that may use radio frequency (RF) communications to communicate with another device (or user), for example, as a participant in a communication network, such as the IoE. Such communications may include communications with another wireless device, a base station (including a cellular communication network base station and an IoE base station), an access point (including an IoE access point), or other wireless devices.

A device implementing various embodiments may include any one or all of cellular telephones, smart phones, personal or mobile multi-media players, personal data assistants (PDAs), laptop computers, tablet computers, smart books, palmtop computers, gaming systems and controllers, smart appliances including televisions, set top boxes, kitchen appliances, lights and lighting systems, smart electricity meters, air conditioning/HVAC systems, thermostats, building security systems including door and window locks, vehicular entertainment systems, vehicular diagnostic and monitoring systems, unmanned and/or semi-autonomous aerial vehicles, automobiles, sensors, machine-to-machine devices, and similar devices that include a programmable processor and memory and circuitry for establishing wireless communication pathways and transmitting/receiving data via wireless communication pathways.

The term “component” is intended to include a computer-related part, functionality or entity, such as, but not limited to, hardware, firmware, a combination of hardware and software, software, or software in execution, that is configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

IoE devices may be deployed in locations or areas without ready sources of power, requiring the devices to rely on power stored in a battery or another stored power source. Some IoE devices may also be required or expected to operate without battery replacement or recharging for long periods of time, extending into years. The efficient use of stored power and minimizing wasted power consumption are necessary to meet this operational requirement.

To establish a communication link with a wireless communication network (e.g., a cellular communication network), an IoE device may transmit a request to establish the communication link (such as a Random Access Channel (RACH) request) at a certain transmit power. If the request to establish the communication link is not successful (e.g., if the IoE device does not receive a response or acknowledgement from the base station) a conventional IoE device will transmit a second request at increase transmit power. A conventional IoE device will repeat this process until an acknowledgement or response is received from the base station, or the IoE device determines that all requests have failed. This conventional process wastes battery power of the IoE device. In addition, if the request to establish the communication link collides with another IoE device's request to establish a communication link, the processes will be prolonged, further wasting power.

Various embodiments provide methods implemented by a processor on an IoE device for managing power resources of the IoE device establishing communication links with a wireless communication network. In various embodiments, the IoE device may monitor uplink interference over time and store in memory wireless communication parameters. The wireless communication parameters stored in memory may include the monitored uplink interference over time, a transmit power of successful communication link requests, and a time that each successful request was sent. When the IoE device determines that the device has data to transmit to the communication network, the IoE device may calculate a transmit power based on the stored wireless communication parameters at the transmit time. For example, the IoE device may correlate the transmit time and the stored wireless communication parameters associated with that time, and the IoE device may calculate a transmit power based on the stored wireless communication parameters that are associated with the transmit time.

If the request to establish the communication link is successful, the IoE device may store in the memory the calculated transmit power of the successful request, as well as the time the request was sent, and wireless communication parameters.

In some embodiments, the IoE device may also determine the transmit time based on the stored wireless communication parameters. For example, the IoE device may determine a transmit time at which a very low level of uplink interference is expected. Transmitting during a time of low uplink interference may enable the IoE device to use a lower transmit power level to successfully establish a wireless communication link.

In some embodiments, two or more IoE devices may share timing information about upcoming requests to establish a communication link. For example, a first IoE device may send and/or receive a transmit timing to and/or from one or more second IoE devices. The IoE devices may determine a respective transmit time that avoids colliding (i.e., overlapping partially or wholly in time) with requests to establish a communication link from other IoE devices. Each IoE device may thus determine a transmit time for when other IoE devices are not transmitting. In some embodiments, two or more IoE devices may negotiate a transmit time in order to avoid a request collision.

In some embodiments, two or more IoE devices may share wireless communication parameters. For example, IoE devices may transmit to each other observed wireless communication parameters, such as uplink interference over time, the transmit power of successful communication link requests, and a time that each successful request was sent. In some embodiments, the IoE devices may communicate with each other over device-to-device (D2D) communication links. Each IoE device may store the received wireless communication parameters together with its own calculated wireless communication parameters, thereby enabling each IoE device to build a robust database of wireless communication parameters over time.

In summary, an IoE device may monitor uplink interference over time and calculate wireless communication parameters to reduce the transmit power required for a successful request to establish a communication link with a communication network. Using the calculated wireless communication parameters to calculate the transmit power of the request to establish the communication link may also reduce delay in establishing the communication link caused by transmitting one or more unsuccessful requests (which may be unsuccessful because of collisions with other IoE device requests or because of insufficient transmit power). Additionally, using stored parameters to calculate the transmit power of the request to establish the communication link may also reduce delay may also reduce delay because the IoE device does not need to receive or determine information broadcast by the communication network to obtain a parameter when needed. Further, using the calculated wireless communication parameters to calculate the transmit power of the request establish the communication link may also may also preserve stored power resources for the IoE device.

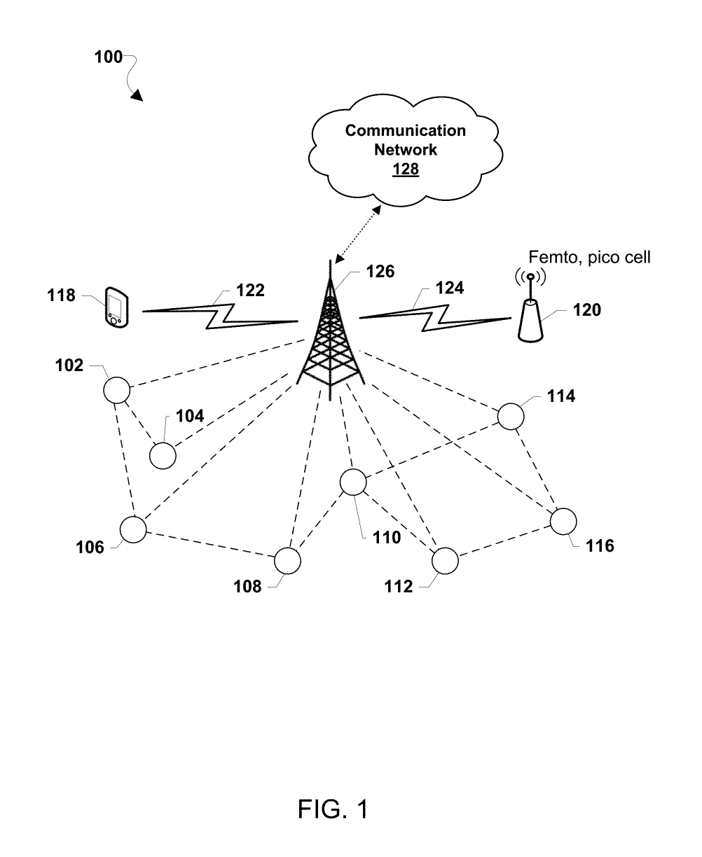

Various embodiments may be implemented in one or more IoE devices that may operate within a variety of communication environments, an example of which is illustrated in FIG. 1. A communication environment 100 may include a plurality of IoE devices, such as IoE devices 102-116, which may transmit and receive RF signals that propagate through the communication environment 100. Each IoE device 102-116 may communication with at least one other IoE device 102-116 over one or more wireless communication links (illustrated with dashed lines). In some embodiments, the IoE devices 102-116 may function as an IoE mesh network. As such, in some embodiments, the IoE devices 102-116 may be participants in a massively distributed computing network. In some embodiments, one of the IoE devices 102-116 may be selected to function as a master node capable of issuing instructions to one or more other wireless network nodes.

Each IoE device 102-116 may also communicate with a wireless network base station 126 over one or more wireless communication links. The wireless network base station 126 may provide access to a communication network 128 for the IoE devices 102-116, either through direct communication with the wireless network base station or indirectly (e.g., “daisy chained”) through one or more of the IoE devices 102-116.

The base station 126 may include a cellular network base station, which may support communications for a variety of other wireless communication devices. Such wireless communication devices may include mobile communication devices 118, which may communicate with the base station 126 over a communication link 122. Such wireless communication devices may also include small cells or a wireless access points 120, which may include a micro cell, a femto cell, a pico cell, a Wi-Fi access point, and other similar network access points. The mobile communication devices 118 and wireless access points 120 may communicate with the base station over a wireless communication link 124.

The wireless communication links among the IoE devices 102-116 and between the IoE devices and the base station 126 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication links within the communication environment 100 include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication environment 100 include medium range protocols such as Wi-Fi, LTE-U, LTE-Direct, LAA, MuLTEfire, and relatively short range RATs such as Wi-Fi, ZigBee, Bluetooth, and Bluetooth Low Energy (LE). In some embodiments, some of the communication links may use an IoE communication protocol. An IoE communication protocol may include LTE Machine-Type Communication (LTE MTC), Narrow Band LTE (NB-LTE), Cellular IoT (CIoT), Narrow Band IoT (NB-IoT), BT Smart, Bluetooth Low Energy (BT-LE), Institute of Electrical and Electronics Engineers (IEEE) 802.15.4, and extended range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. In some embodiments, the frequencies used for wireless communication links may be in the 3.5 GHz band.

Thus, the communication environment 100 may include a wide variety of communication links with the base station 126, including the various wireless communication links with the IoE devices 102-116, as well as with the mobile communication devices 118 and the small cells 120. As the number of wireless communication links in the communication environment 100 increases, the degree of communication link interference may increase as well.

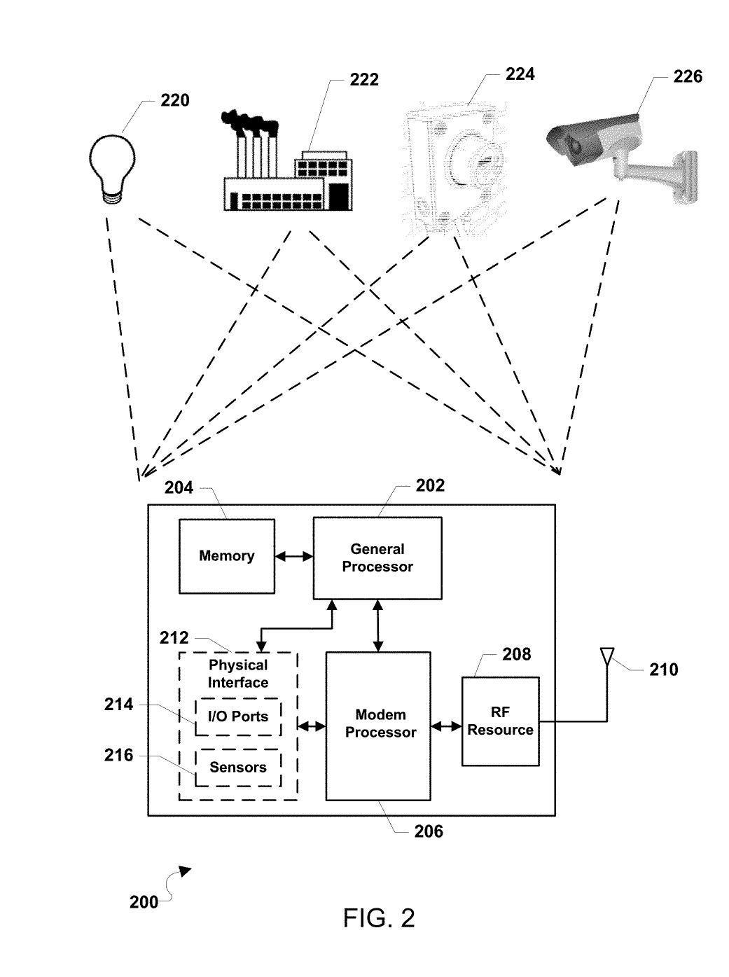

FIG. 2 is a component block diagram of an IoE device 200 suitable for implementing various embodiments. In various embodiments, the IoE device 200 may be similar to the IoE devices 102-116 shown in FIG. 1. IoE devices 200 may be built into a variety of devices, including wireless access points supporting local wireless networks and smart appliances communicating with wireless networks. Non-limiting examples of smart appliances include televisions, set top boxes, kitchen appliances, lights and lighting systems, smart electricity meters, air conditioning/HVAC systems, thermostats, building security systems, doors and windows, door and window locks, and building diagnostic and monitoring systems. An IoE device 200 may also be in communication with, or coupled to, a system, device, or structure. Non-limiting examples of systems that may implement IoE devices 200 include a lighting system 220, one or more components or elements in a factory 222, a smart meter or power monitoring system 224, and an residential or commercial security system 226.

An IoE device 200 may include at least one processor, such as a general processor 202, which may be coupled to at least one memory 204. The memory 204 may be a non-transitory computer-readable storage medium that stores processor-executable instructions. The memory 204 may store an operating system, user application software, and/or other executable instructions. The memory 204 may also store application data, such as an array data structure. The memory 204 may include one or more caches, read only memory (ROM), random access memory (RAM), electrically erasable programmable ROM (EEPROM), static RAM (SRAM), dynamic RAM (DRAM), or other types of memory. The general processor 202 may read and write information to and from the memory 204. The memory 204 may also store instructions associated with one or more protocol stacks. A protocol stack generally includes computer executable instructions to enable communication using a radio access protocol or communication protocol.

The processor 202 and the memory 204 may communicate with at least one modem processor 206. The modem processor 206 may perform modem functions for communications with one or more other IoE devices, access points, base stations, and other such devices. The modem processor 206 may be coupled to an RF resource 208. The RF resource 208 may include various circuitry and components to enable the sending, receiving, and processing of radio signals, such as a modulator/demodulator component, a power amplifier, a gain stage, a digital signal processor (DSP), a signal amplifier, a filter, and other such components. The RF resource 208 may be coupled to a wireless antenna (e.g., a wireless antenna 210). The IoE device 200 may include additional RF resources and/or antennas without limitation. The RF resource 208 may be configured to provide communications using one or more frequency bands via the antenna 210.

In some embodiments, the processor 202 may also communicate with a physical interface 212 configured to enable a wired connection to another device. The physical interface 212 may include one or more input/output (I/O) ports 214 configured to enable communications with the device to which the IoE device is connected. The physical interface 212 may also include one or more sensors 216 to enable the IoE device to detect information about a device with which the IoE device 200 is connected via the physical interface 212. Examples of devices with which the IoE device may be connected include smart appliances including televisions, set top boxes, kitchen appliances, lights and lighting systems, smart electricity meters, air conditioning/HVAC systems, thermostats, building security systems, doors and windows, door and window locks, building diagnostic and monitoring systems, and other devices.

The IoE device 200 may also include a bus for connecting the various components of the IoE device 200 together, as well as hardware and/or software interfaces to enable communication among the various components. The IoE device 200 may also include various other components not illustrated in FIG. 2. For example, the IoE device 200 may include a number of input, output, and processing components, such as buttons, lights, switches, antennas, display screen or touchscreen, various connection ports, additional processors or integrated circuits, and many other components.

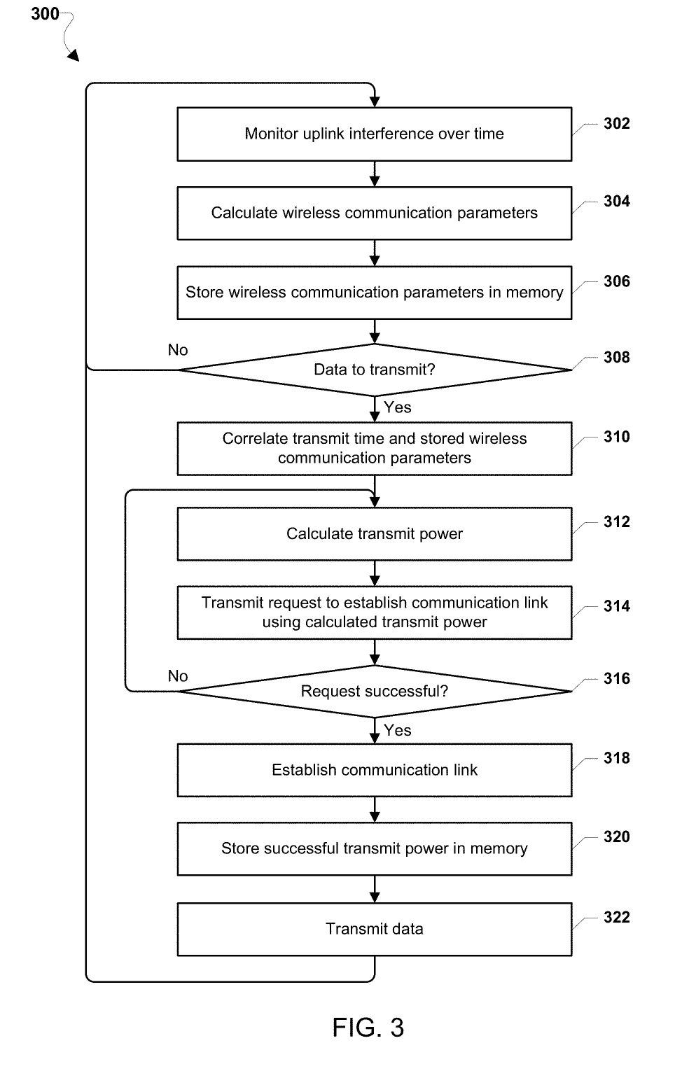

FIG. 3 is a process flow diagram illustrating a method 300 for managing power resources of an IoE device according to some embodiments. With reference to FIGS. 1-3, the method 300 may be implemented by a processor (e.g., the general processor 202 or another similar processor) of an IoE device (e.g., the IoE devices 102-116 and 200).

In block 302, the processor of the IoE device (a “device processor”) may monitor uplink interference over time. For example, the device processor may monitor one or more RF signals over time within a communication environment (such as the communication environment 100) that may interfere with a communication link between the IoE device and a communication network (e.g., the base station 126). In some embodiments, the device processor may determine whether a signal strength of the received signal(s) is sufficiently large (e.g., exceeds a signal strength threshold) that the signal(s) may interfere with the communication link between the IoE device and the communication network. In some embodiments, the device processor may compare the signal strength of the received signal(s) to two or more thresholds to determine a severity of the potential interference caused by the received signal(s).

In block 304, the device processor may calculate wireless communication parameters based on the monitored uplink interference over time. The wireless communication parameters may also include one or more interference metrics based on the monitored uplink interference over time, and a time that the one or more interference metrics are detected. The wireless communication parameters may also include a transmit power of any successful requests to establish a communication link with the communication network, as well as a time when each successful request to establish a communication link was sent. In some embodiments, a time may be a precise time, or a time range. In some embodiments, other wireless communication parameters may be indexed according to a detection time and/or a time when a successful request to establish a communication link is sent.

In various embodiments, the wireless communication parameters may include one or more cell parameters associated with a cell of the communication network with which the IoE device may communicate. Cell parameters may include a cell identifier, a communication link channel identifier (e.g., an Absolute Radio Frequency Channel Number), and one or more RATs detected in the cell. Cell parameters may enable the IoE device to identify one or more carriers and/or or one or more RATs available to the IoE device for communications in the cell.

In some embodiments, the wireless communication parameters may include a number of unsuccessful requests to establish a communication link sent prior to a successful request, as well as the time each unsuccessful request was sent. The number of unsuccessful requests may provide an indication of a frequency of collisions between requests to establish a communication link sent by two or more IoE devices. A high frequency of collisions may reduce the probability of sending a successful communication link request, even if an IoE device sends a request at a sufficiently high transmit power. One example of a request to establish communication link is a Random Access Channel (RACH) preamble.

In some embodiments, the wireless communication parameters may include a path loss detected or estimated by the device processor when a successful request to establish communication link is sent. In some embodiments, the device processor may estimate the path loss using, for example, a reference signal power (RS Power) provided by the communication network (e.g., sent by a base station) and a reference signal received power (RSRP) measured by the device processor. In some embodiments, the device processor may use the path loss to determine a transmit power of a future request to establish a communication link.

In block 306, the device processor may store the wireless communication parameters in a memory of the IoE device. In some embodiments, the device processor may store the wireless communication parameters in a data structure, such as a database.

In determination block 308, the device processor may determine whether the IoE device has any data to transmit to the communication network. The data to transmit may include a status report, information obtained by a sensor of the IoE device, and/or information related to a device coupled to the IoE device (such as, for example, an appliance, or another residential or business system).

In response to determining that the IoE device does not have any data to transmit (i.e., determination block 308=“No”), the device processor may continue to monitor uplink interference over time in block 302.

In response to determining that the IoE device does have data to transmit (i.e., determination block 308=“Yes”), the device processor may correlate a transmit time and one or more stored wireless communication parameters in operation 310. The transmit time may be a time or time range in the future during which the device processor may transmit data to the communication network.

In block 312, the device processor may calculate a transmit power for a request to establish a communication link based on one or more stored wireless communication parameters associated with the transmit time. The device processor may calculate the transmit power using one or more stored wireless communication parameters alone or in any combination. The device processor may also calculate the transmit power using one or more stored wireless communication parameters of a factor to calculate the transmit power. For example, the device processor may determine a selected transmit time and one or more wireless communication parameters that are correlated with (or associated with) the transmit time from the memory of the IoE device. The device processor may calculate the transmit power for the request to establish the communication link using one or more wireless communication parameters correlated with the transmit time.

In some embodiments, the device processor may also use a path loss correlated with the transmit time to calculate the transmit power. In some embodiments, the device processor may also use a stored power level (e.g., a battery level) to calculate the transmit power. For example, the device processor may determine that the stored power level is below a power level threshold. In response to determining that the stored power level is below the power level threshold, the device processor may decrease the transmit power (e.g., by decreasing a calculated transmit power, or by adding a factor to the calculation of the transmit power). In some embodiments, the device processor may lower a previously-successful transmit power by one or more power ramp-up steps to determine the transmit power.

In some embodiments, the device processor may also use currently detected wireless communication parameters to calculate the transmit power. For example, the device processor may use a currently-received RS Power, RSRP, or another measure of communication link robustness, or another measure of uplink interference, to calculate the transmit power. For example, the device processor may determine that a currently estimated path loss is lower than a time-correlated path loss stored in memory, and based on this determination the device processor may decrease the transmit power. As another example, the device processor may determine that one or more current communication link conditions are inferior to time-correlated communication link or uplink interference conditions stored in memory, and the device processor may increase the transmit power accordingly.

In block 314, the device processor may transmit a request to establish a communication link using the calculated transmit power.

In determination block 316, the device processor may determine whether the request is successful. For example, the device processor may determine whether the IoE device receives an acknowledgment from the communication network (e.g., an ACK message from the base station).

In response to determining that the request is not successful (i.e., determination block 316=“No”), the device processor may calculate another transmit power in block 312.

In response to determining that the request is successful (i.e., determination block 316=“Yes”), the device processor may establish the communication link with the communication network in block 318, and store the calculated transmit power of the successful request to establish the communication link in the memory in block 320. In some embodiments, the device processor may also store one or more uplink interference parameters and/or one or more wireless communication parameters that the device processor may associate with the transmission time of the successful request to establish the communication link.

In block 322, the device processor may communicate with the communication link via the established communication link, such as transmitting data to the communication network. In some embodiments, the IoE device may also determine whether a second IoE device that is within device-to-device (D2D) communication range also has data to transmit to the communication network. In such embodiments, the first and second IoE devices may establish a D2D communication link, and the second IoE device may transmit its data to the first IoE device for transmission from the first IoE device to the communication network. Thus, the second IoE device may “piggyback” its data to the communication network via the communication link between the first IoE device in the communication network.

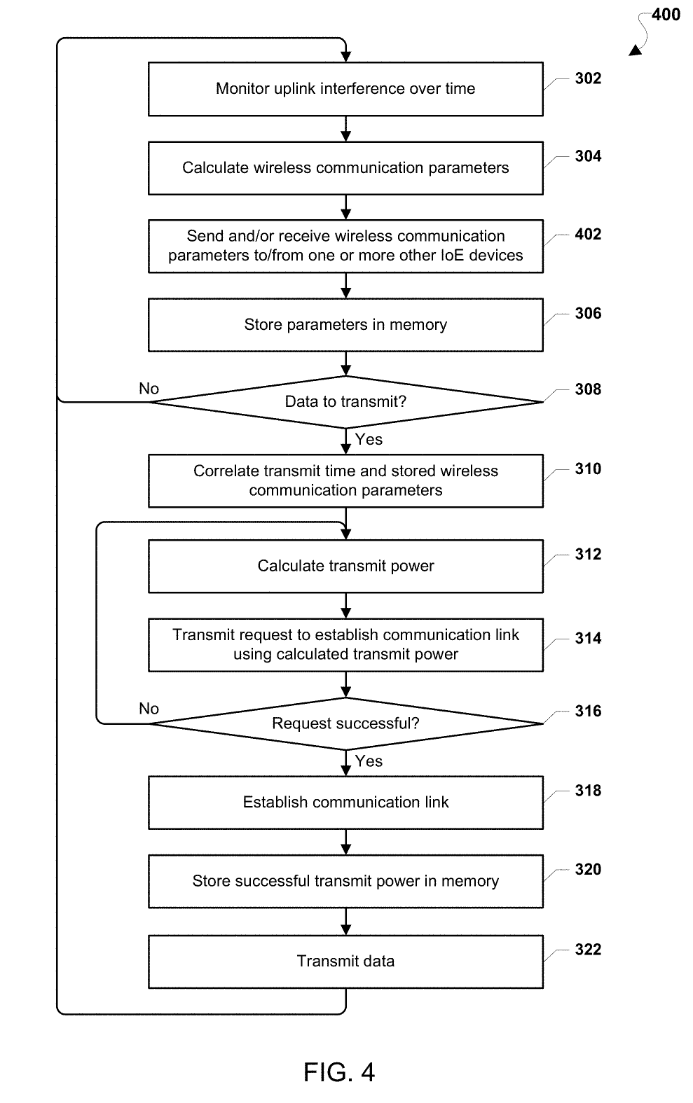

FIG. 4 is a process flow diagram illustrating a method 400 for managing power resources of an IoE device according to some embodiments. With reference to FIGS. 1-4, the method 400 may be implemented by a device processor (e.g., the general processor 202 or another similar processor) of an IoE device (e.g., the IoE devices 102-116 and 200). In blocks 302-322, the device processor may perform operations of like numbered blocks of the method 300 as described with reference to FIG. 3.

In block 402, the device processor may send and/or receive wireless communication parameters to and/or from one or more other IoE devices. In some embodiments, two or more IoE devices may share (i.e., transmit to one another) wireless communication parameters calculated from the uplink interference observations of each IoE device, as well as other information regarding wireless communication links between each IoE device in the communication network. Thus, an IoE device may send to and receive from other IoE devices information obtained from monitoring uplink interference over time, transmit powers of successful requests to establish a communication link, times of each successful and/or unsuccessful requests to establish a communication link, cell parameters, data (e.g., numbers and times) on unsuccessful requests to establish communication links, path loss information, and other wireless communication link information associated with successful requests to establish a communication link. By so doing, each IoE device may build up a robust store of information based on observations of other IoE devices, as well as the IoE device itself In some embodiments, each IoE device may share an assembled data structure, such as a database, that may provide one or more correlations of the various information stored therein.

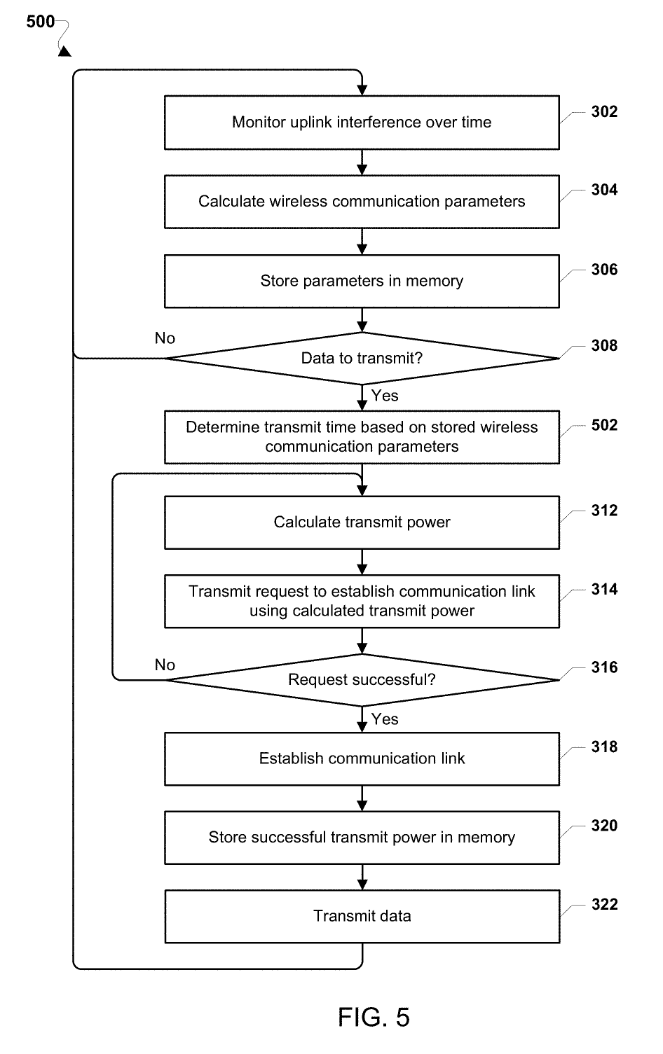

FIG. 5 is a process flow diagram illustrating a method 500 for managing power resources of an IoE device according to some embodiments. With reference to FIGS. 1-5, the method 500 may be implemented by a device processor (e.g., the general processor 202 or another similar processor) of an IoE device (e.g., the IoE devices 102-116 and 200). In blocks 302-322, the device processor may perform operations of like numbered blocks of the method 300 as described with reference to FIG. 3.

In block 502, the device processor may determine a transmit time based on one or more stored wireless communication parameters. The device processor may use the stored wireless communication parameters individually or in combination to determine the transmit time. The device processor may also use one or more stored wireless communication parameters as factors to determine the transmit time.

For example, the device processor may identify a time of a relatively high number of successful requests to establish a communication link (e.g., a successful number of requests above a threshold number of requests). The device processor may also identify a time of relatively low uplink interference (e.g., uplink interference below a threshold uplink interference). Additionally, the device processor may identify a time of relatively low collisions of requests to establish a communication link (e.g., a number of collisions below a threshold number of collisions. The device processor may also identify a time at which a successful transmit power is below a threshold transmit power level. In addition, the device processor may identify a time when a path loss is below a threshold path loss.

Thus, the device processor may determine a transmit time at which the request to establish the communication link is highly likely to be successful, such that the IoE device is not required to transmit additional requests. Additionally or alternatively, the device processor may determine a transmit time at which a lowest or nearly lowest transmit power is required for a successful request.

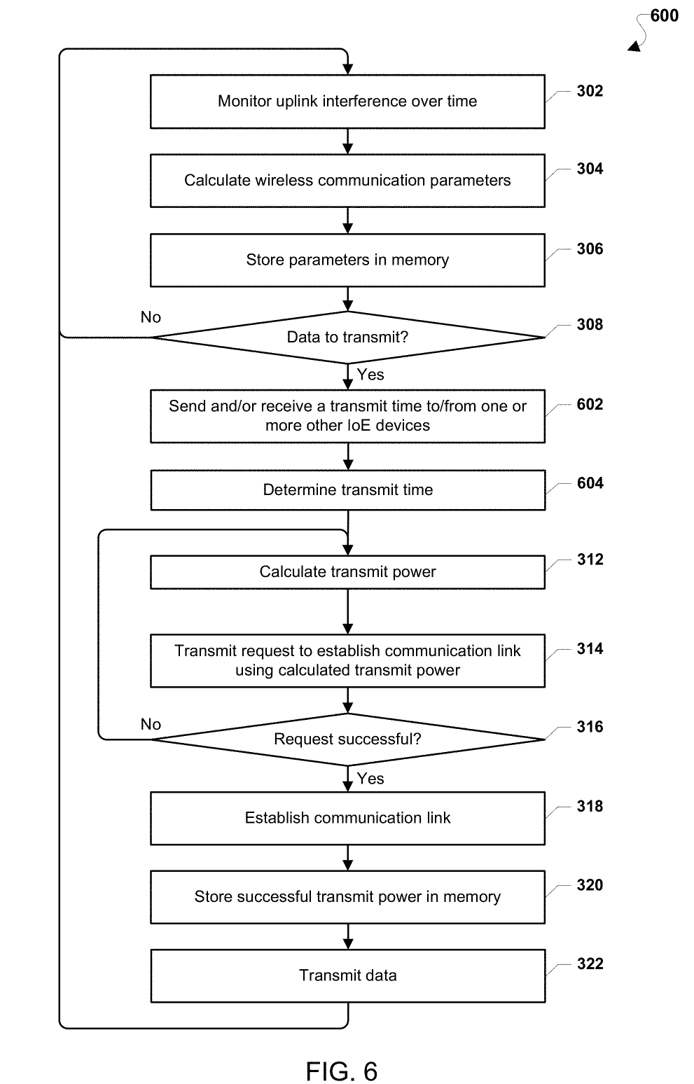

FIG. 6 is a process flow diagram illustrating a method 600 for managing power resources of an IoE device according to some embodiments. With reference to FIGS. 1-6, the method 600 may be implemented by a device processor (e.g., the general processor 202 or another similar processor) of an IoE device (e.g., the IoE devices 102-116 and 200). In blocks 302-322, the device processor may perform operations of like numbered blocks of the method 300 as described with reference to FIG. 3.

In block 602, the device processor may send and/or receive a transmit time to and/or from one or more other IoE devices.

In block 604, the device processor may determine a transmit time based on one or more transmit times received from other IoE devices. In various embodiments, the device processor may determine the transmit time for the IoE device based on one or more stored wireless communication parameters as well as the one or more transmit times received from other IoE devices.

In some embodiments, the device processor may use the received one or more transmit times from the other IoE devices to determine a transmit time that avoids a collision between a request to establish communication link sent from the IoE device and another request sent by a different IoE device. In some embodiments, each of a plurality of IoE devices may share a determine transmit time, and each of the plurality of IoE devices may negotiate a transmit time that avoids collisions between requests (e.g., avoids as many collisions as possible).

Thus, an IoE device may monitor uplink interference over time and calculate wireless communication parameters to reduce the transmit power required for a successful request to establish a communication link with a communication network. Using the calculated wireless communication parameters to calculate the transmit power of the request establish the communication link may also reduce delay in establishing the communication link caused by transmitting one or more unsuccessful requests, which may be unsuccessful because of collisions with other IoE device requests to establish can occasionally, or because of insufficient transmit power. Further, using the calculated wireless communication parameters to calculate the transmit power of the request establish the communication link may also may also preserve stored power resources for the IoE device.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300, 400, 500, and 600 may be substituted for or combined with one or more operations of the methods 300, 400, 500, and 600.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the device processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A method of managing power resources of an Internet of Everything (IoE) device, comprising:
monitoring an uplink interference over time by a device processor of the IoE device;
calculating, by the device processor, wireless communication parameters based on the monitored uplink interference over time;
storing in the calculated wireless communication parameters a memory of the IoE device;
calculating, by the device processor, a transmit power based on one or more stored wireless communication parameters associated with a transmit time; and
transmitting to a communication network a request to establish a communication link using the calculated transmit power.

2. The method of claim 1, wherein the uplink interference comprises uplink interference in a cell of the communication network.

3. The method of claim 1, wherein calculating the transmit power based on the stored wireless communication parameters at a transmit time comprises:
correlating, by the device processor, the transmit time and the stored wireless communication parameters.

4. The method of claim 3, further comprising:
determining, by the device processor, whether the IoE device has data to transmit; and
correlating the transmit time and the stored wireless communication parameters by the device processor in response to determining that the IoE device has data to transmit.

5. The method of claim 1, further comprising:
determining, by the device processor, whether the request to establish the communication link is successful; and
calculating, by the device processor, a second transmit power based on the stored wireless communication parameters at the transmit time in response to determining that the transmitted request is not successful.

6. The method of claim 5, further comprising:
establishing the communication link with the communication network in response to determining that the request to establish the communication link is successful; and
storing in the memory the successful transmit power.

7. The method of claim 1, further comprising:
determining, by the device processor, a transmit time based on the stored wireless communication parameters.

8. The method of claim 1, further comprising:
determining, by the device processor, a transmit time based on the stored wireless communication parameters and a second transmit time of one or more other IoE devices.

9. The method of claim 1, further comprising:
receiving from one or more other IoE devices second wireless communication parameters; and
storing in the memory the second wireless communication parameters.

10. An Internet of Everything (IoE) device, comprising:
a radio frequency (RF) resource; and
a processor coupled to the RF resource and configured with processor-executable instructions to perform operations comprising:
monitoring an uplink interference over time by a device processor of the IoE device;
calculating wireless communication parameters based on the monitored uplink interference over time;
storing in the calculated wireless communication parameters a memory of the IoE device;
calculating a transmit power based on one or more stored wireless communication parameters associated with a transmit time; and
transmitting to a communication network a request to establish a communication link using the calculated transmit power.

11. The IoE device of claim 10, wherein the processor is configured with processor-executable instructions to perform operations such that the uplink interference comprises uplink interference in a cell of the communication network.

12. The IoE device of claim 10, wherein the processor is configured with processor-executable instructions to perform operations such that calculating the transmit power based on the stored wireless communication parameters at a transmit time comprises:
correlating the transmit time and the stored wireless communication parameters.

13. The IoE device of claim 12, wherein the processor is configured with processor-executable instructions to perform operations further comprising:
determining whether the IoE device has data to transmit; and
correlating the transmit time and the stored wireless communication parameters in response by the device processor to determining that the IoE device has data to transmit.

14. The IoE device of claim 10, wherein the processor is configured with processor-executable instructions to perform operations further comprising:
determining whether the request to establish the communication link is successful; and
calculating a second transmit power based on the stored wireless communication parameters at the transmit time in response to determining that the transmitted request is not successful.

15. The IoE device of claim 14, wherein the processor is configured with processor-executable instructions to perform operations further comprising:
establishing the communication link with the communication network in response to determining that the request to establish the communication link is successful; and
storing in the memory the successful transmit power.

16. The IoE device of claim 10, wherein the processor is configured with processor-executable instructions to perform operations further comprising:
determining a transmit time based on the stored wireless communication parameters.

17. The IoE device of claim 10, wherein the processor is configured with processor-executable instructions to perform operations further comprising:
determining a transmit time based on the stored wireless communication parameters and a second transmit time of one or more other IoE devices.

18. The IoE device of claim 10, wherein the processor is configured with processor-executable instructions to perform operations further comprising:
receiving from one or more other IoE devices second wireless communication parameters; and
storing in the memory the second wireless communication parameters.

19. A non-transitory processor-readable storage medium having stored thereon processor-executable instructions configured to cause a processor of an Internet of Everything (IoE) device to perform operations for managing power resources of the IoE device, comprising:
monitoring an uplink interference over time by a device processor of the IoE device;
calculating wireless communication parameters based on the monitored uplink interference over time;
storing in the calculated wireless communication parameters a memory of the IoE device;
calculating a transmit power based on one or more stored wireless communication parameters associated with a transmit time; and
transmitting to a communication network a request to establish a communication link using the calculated transmit power.

20. The non-transitory processor-readable storage medium of claim 19, wherein the stored processor-executable instructions are configured to cause the processor of the multimode communication device to perform operations such that the uplink interference comprises uplink interference in a cell of the communication network.

21. The non-transitory processor-readable storage medium of claim 19, wherein the stored processor-executable instructions are configured to cause the processor of the multimode communication device to perform operations such that calculating the transmit power based on the stored wireless communication parameters at a transmit time comprises:
correlating, the transmit time and the stored wireless communication parameters.

22. The non-transitory processor-readable storage medium of claim 21, wherein the stored processor-executable instructions are configured to cause the processor of the multimode communication device to perform operations further comprising:
determining whether the IoE device has data to transmit; and
correlating the transmit time and the stored wireless communication parameters in response to determining that the IoE device has data to transmit.

23. The non-transitory processor-readable storage medium of claim 19, wherein the stored processor-executable instructions are configured to cause the processor of the multimode communication device to perform operations further comprising:
determining whether the request to establish the communication link is successful; and
calculating a second transmit power based on the stored wireless communication parameters at the transmit time in response to determining that the transmitted request is not successful.

24. The non-transitory processor-readable storage medium of claim 23, wherein the stored processor-executable instructions are configured to cause the processor of the multimode communication device to perform operations further comprising:
establishing the communication link with the communication network in response to determining that the request to establish the communication link is successful; and
storing in the memory the successful transmit power.

25. The non-transitory processor-readable storage medium of claim 19, wherein the stored processor-executable instructions are configured to cause the processor of the multimode communication device to perform operations further comprising:
determining a transmit time based on the stored wireless communication parameters.

26. The non-transitory processor-readable storage medium of claim 19, wherein the stored processor-executable instructions are configured to cause the processor of the multimode communication device to perform operations further comprising:
determining a transmit time based on the stored wireless communication parameters and a second transmit time of one or more other IoE devices.

27. The non-transitory processor-readable storage medium of claim 19, wherein the stored processor-executable instructions are configured to cause the processor of the multimode communication device to perform operations further comprising:
receiving from one or more other IoE devices second wireless communication parameters; and
storing in the memory the second wireless communication parameters.

28. An Internet of Everything (IoE) device, comprising:
means for monitoring an uplink interference over time by a device processor of the IoE device;
means for calculating wireless communication parameters based on the monitored uplink interference over time;
means for storing in the calculated wireless communication parameters a memory of the IoE device;
means for calculating a transmit power based on one or more stored wireless communication parameters associated with a transmit time; and
means for transmitting to a communication network a request to establish a communication link using the calculated transmit power.

29. The IoE device of claim 28, wherein the uplink interference comprises uplink interference in a cell of the communication network.

30. The IoE device of claim 28, wherein means for calculating the transmit power based on the stored wireless communication parameters at a transmit time comprises:
means for correlating the transmit time and the stored wireless communication parameters.
